(19) United States
(12) Patent Application Publication
(10) Pub. No.: US 2026/0257334 A1
(43) Pub. Date: Sep. 3, 2026

(54) Application Selector for a Power Tool

(71) Applicant: Robert Bosch GmbH, Stuttgart (DE)

(72) Inventors: Melchor Israel Chairez Lizcano, Baja California (MX); Balazs Nagy, Roselle, IL (US)

(21) Appl. No.: 18/993,695

(22) PCT Filed: Jul. 12, 2023
(86) PCT No.: PCT/EP2023/069318

§ 371 Date: Jan. 13, 2025

Related U.S. Application Data
(60) Provisional application No. 63/389,437, filed on Jul. 15, 2022.

(30) Foreign Application Priority Data
Jul. 15, 2022 (US) 63389437

(51) Int. Cl. B25F 5/02

(52) U.S. Cl. CPC B25F 5/02

(57) ABSTRACT

A hand-held power tool includes a user interface that is supported on the housing. A controller controls the user interface to display at least one icon representing a unique tool application and controls the motor to operate in a predetermined speed range based on an application selection by the user and obtained from the user interface. The user interface is configured to permit the user to perform the application selection from a menu of icons including the at least one icon.

### BACKGROUND

Hand held power tools are capable of being equipped with a variety of tool accessories and attachments, such as cutting blades, sanding discs, grinding tools, and many others. An oscillating tool is one example of such a power tool, which typically includes a generally cylindrically shaped main body that serves as an enclosure for an electric motor as well as a hand grip for the tool. The electric motor drives a mechanism that generates an oscillating motion for oscillating an accessory interface to which any one of various accessory tools may be attached.

As the tool holder is oscillated, an accessory tool attached to the tool holder is driven to perform a particular function, such as sanding, grinding, cutting, scraping, grout removal, etc. depending on the configuration of the accessory tool.

Some hand-held power tools allow the user to control the speed of the motor, for example by changing a rotational orientation of a speed knob or wheel. In many tools, the tool provides an indication of relative speed change for a given change in rotational orientation of the wheel. For example, the wheel may be rotated between a setting of “1” for minimum speed and “10” for maximum speed. However, in some tools, the actual tool speed for a given knob orientation may not be obvious to a user. Moreover, users who use tools infrequently may not be aware of the optimal speed for a given application.

Because oscillating tools are a relatively new type of power tool, the uncertainty in identifying and implementing a correct tool speed for a given application is increased. In addition, since oscillating tools may be used in a wide-ranging variety of applications, the correspondingly wide available range of operating speeds may make it difficult to identify and implement the most appropriate speed selection for a given application. If the speed setting of the tool is not optimized for the intended application or is inappropriate for the intended application, the user experience and the operating effectiveness of the tool may be adversely affected.

### SUMMARY

In some aspects, a hand-held power tool includes a brushless electric motor that is housed in a housing that also serves as a tool handle. In some embodiments, an output shaft of the motor is directly connected to an accessory whereby the accessory moves in a rotational motion. In other embodiments, the output shaft of the motor is connected to an accessory via an intermediate motion change mechanism that provides the accessory with an oscillating motion.

The tool may also include a rechargeable battery pack that supplies power to the motor, a variable speed trigger for precise speed control, mechanisms which permit the tool to be locked in a power on state and/or a power off state, and a user interface that includes an “application selector.” The application selector allows the user to select an application such as cutting or sanding rather than selecting a speed. The tool may include a controller that receives the application selection from the user interface, determines an appropriate range of tool speeds for the selected application and then limits the motor speed of the tool to the range of tool speeds appropriate to the application selection.

The user interface presents the application selector to the user of the tool. The application selector includes icons that represent typical tool applications. The user interface is configured to permit the user to select a tool application from a menu of tool applications, where each tool application is represented as a unique icon on the user interface. In some embodiments, the representations of the icons may be schematic in nature and/or may be of a simple, easy to read geometry.

In one exemplary and non-limiting embodiment, the application selector may include a first icon that represents a scraping application of the power tool. In this embodiment, the first icon may be an outline of a rectangle having a single jagged edge, giving the appearance of a rectangular cutting blade. The application selector may include a second icon that represents a sanding application of the power tool. In this embodiment, the second icon may be an outline of a triangle and may have the appearance of triangular sanding pad. The application selector may include a third icon that represents a wood cutting application of the power tool. In this embodiment, the third icon may have the appearance of piece of wood that includes wood grain. In addition, the application selector may include a fourth icon that represents a sanding application of the power tool. In this example, the fourth icon may have the appearance of a metal fastener such as a nut. In addition, the application selector may optionally include other icons that do not represent a specific tool application and instead represent a speed range setting that encompasses the full operating speed range of the tool.

Thus, the application selector presents the user with a set of icons that include graphic representations or other appropriate symbols or images to represent typical or suggested tool applications. The user is able to select an icon corresponding to the intended application of the tool, rather than having to input a particular operating speed or select an appropriate motor speed from a range of relative motor speeds. By providing for application selection, the tool becomes more intuitive to use since the user does not have to know what absolute motor speed is appropriate for use in a given application. Instead, the tool provides pre-selected speed ranges for a variety of typical applications and sets the appropriate speed range of the motor based on the selected icon. Advantageously, by using an application selector to set an appropriate speed range for a given application, guess work related to speed selection is removed from tool operation, the user has a better user experience and the curve for learning to use the tool is shortened. In addition, since the tool is operated at the appropriate speed for the application, the operating effectiveness of the tool is maximized, adding further to user satisfaction.

### BRIEF DESCRIPTION OF THE DRAWINGS

FIG. 1 is a perspective view of a hand held oscillating-type power tool including a user interface disposed in the handle.

FIG. 2 is a top plan view of a portion of the tool showing the user interface, where the user interface includes an application selector that provides an array of icons.

FIG. 3 is a schematic diagram of the control system of the power tool.

FIGS. 4-8 are top plan views of a portion of the tool showing an alternative embodiment user interface, where the user interface includes an application selector that provides a single icon selected from a menu of icons stored in memory. In FIG. 4, the single icon is an icon representing battery charge state. In FIG. 5, the single icon is an icon representing a scraping application. In FIG. 6, the single icon is an icon representing a sanding application. In FIG. 7, the single icon is an icon representing a wood cutting application. In FIG. 8, the single icon is an icon representing a metal cutting application.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one of ordinary skill in the art to which this disclosure pertains.

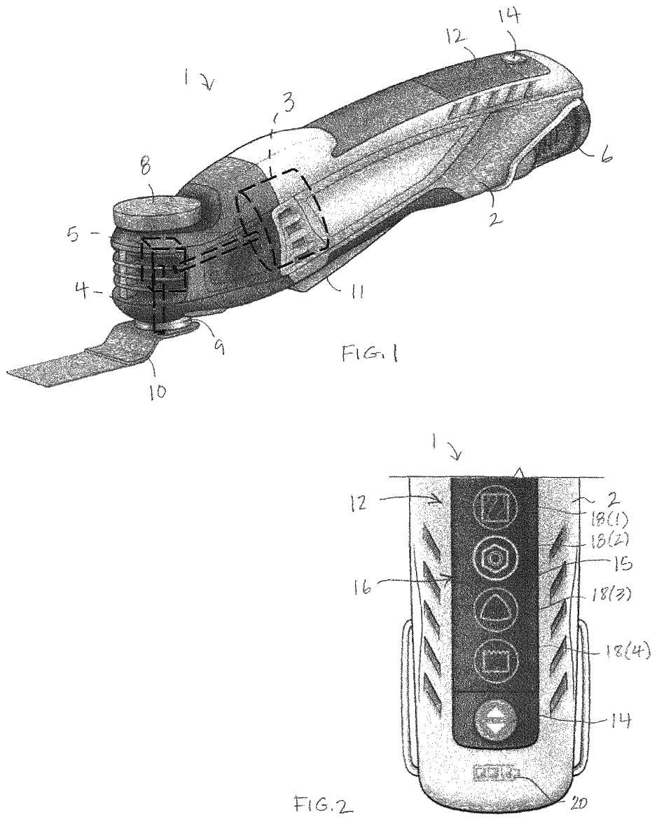

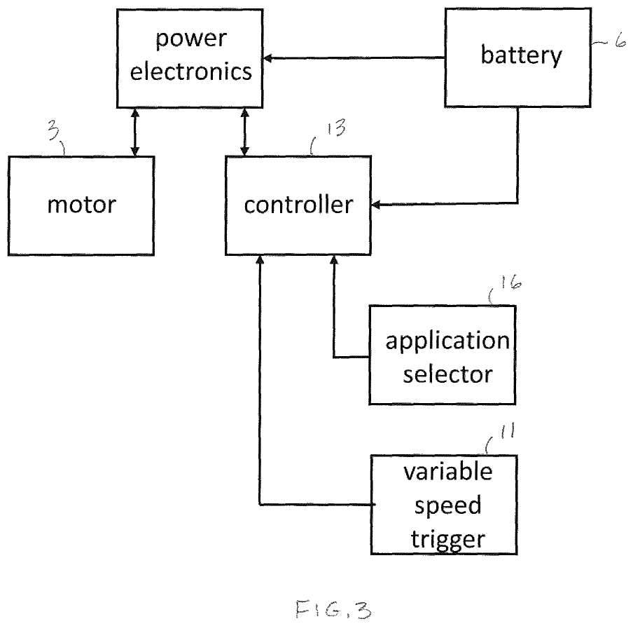

Referring to FIGS. 1-3, a hand-held, oscillating power tool 1 includes a housing 2 that encloses a motor 3 connected to a drive shaft 4 via a motion change mechanism 5. The motion change mechanism 5 imparts an oscillating motion to the rotary output of the motor 3. In addition, the housing 2 receives a rechargeable battery 6. In some embodiments, the tool 1 may receive power from an external source via a wired connection. The housing 2 is configured as a hand grip that is configured to be held by a user. A knob 8 extends outwardly from the housing 2. The knob 8 is operably connected to an accessory interface 9 which extends outwardly from the housing 2 on a side of the housing 2 opposite to the side from which the knob 8 extends. The accessory interface 9 includes features (not shown) that permit connection to an accessory 10.

The knob 8 is operable to permit connection or detachment of the accessory 10 to the accessory interface 9. The details of an exemplary accessory connection mechanism that includes the knob 8 and accessory interface 9 are disclosed in U.S. Pat. No. 10,870,155, the entire contents of which are incorporated herein by reference.

The tool 1 includes a trigger 11 disposed on a portion of the housing 2 accessible to the user's fingers as the user's hand grips the housing 2. In the illustrated embodiment, the trigger 11 protrudes from a lower surface of the housing 2. As used herein, terms describing relative position such as upper, lower, top and bottom are made with reference to the orientation shown in FIG. 1 and are not intended to be limiting. The trigger 11 is connected to the motor 3 via a controller 13. In cooperation with the controller 13, the trigger 11 is configured to permit manual variable control of motor speed.

The tool 1 includes a user interface 12. The user interface 12 is disposed on an upper surface of the housing 2 to permit easy visualization by the user. The user interface 12 includes a display 15 and a scroll button 14 that permits toggling and/or scrolling between possible selections that are presented on the display 15.

In some embodiments, the display 15 displays an application selector 16 that includes an array of icons 18. In the illustrated embodiment, the array is a four by one array that includes four icons 18(1), 18(2), 18(3), 18(4). Although four icons 18(1), 18(2), 18(3), 18(4) are included in the application selector 16, the application selector 16 is not limited to four icons, and may include a fewer or greater number of icons.

An LED (not shown) underlies each icon 18 to permit backlighting of individual icons. Backlighting of an icon 18 is used to indicate selection of that icon 18. A single icon 18 of the array is lit at any given time. The user may toggle or scroll between icons 18 by actuating the scroll button 14. Each time the scroll button 14 is actuated, the icon 18 (for example, the first icon 18(1) being backlit is changed by the controller 13, which causes the next icon (for example, the second icon 18(2)) in the list of icons to be displayed. When the desired icon 18 is backlit in the display 15, the user stops scrolling. The controller 13 identifies which icon 18 is backlit and sets the backlit icon as the selected application. In addition, the controller 13 limits the operation of the motor 3 to a speed range associated with the backlit icon 18.

In this embodiment, the application selector 16 includes the first icon 18(1) that represents a wood cutting application of the tool 1. In this embodiment, the first icon 18(1) appears in the first row of the four by one array and represents a wood cutting application of the power tool. The first icon 18(1) may have a rectangular shape and have the appearance of piece of wood that includes wood grain. The application selector 16 includes the second icon 18(2) that represents a metal cutting application of the tool 1. In this embodiment, the second icon 18(2) is in the second row of the array, and thus appears below the first icon 18(1). The second icon 18(2) may have the appearance of a metal fastener and may be represented by using an outline of a fastener such as a nut. The application selector 16 includes the third icon 18(3) that represents a sanding application of the tool 1. In this embodiment, the third icon 18(3) is in the third row of the array, and thus appears below the second icon 18(2). The third icon 18(3) may be represented using an outline of a triangle and may have the appearance of triangular sanding pad. The application selector 16 includes the fourth icon 18(4) that represents a scraping application of the tool 1. In this embodiment, the fourth icon 18(4) is in the fourth row of the array, and thus appears below the third icon 18(3). The fourth icon 18(4) may be an outline of a rectangle having a single jagged edge, giving the appearance of a rectangular cutting blade.

The application selector 16 of the user interface 12 is configured to permit the user to select a tool application from a menu of tool applications, where each tool application is represented as a unique icon 18. The menu of tool operation applications is stored in memory and includes at least two applications, each of the at least two applications is mapped to a unique range of motor speeds. In some embodiments, the range of motor speeds of one application may be overlapping with a range of motor speeds of another application. In other embodiments, the ranges of the motor speeds of the respective applications are non-overlapping.

In addition to the array of icons 18 that represent applications, the application selector 16 may optionally include other icons (not shown) that do not represent a specific tool application and instead represent a speed range setting that encompasses the full operating speed range of the tool. In some embodiments, the full operating range of speeds provided by the tool 1 may be 10,000 rotations per minute to 20,000 rotations pe minute. By selecting this icon, a user is not limited to a sub-range of the overall tool speed range. In some embodiments, the application selector may include an icon (not shown) allowing selection of a “boost” range of motor speeds. For example the boost range of speeds provided by the tool 1 may be 10,000 rotations per minute to 22,000 rotations pe minute

The display 15 may include the application selector 16 described above, as well as other information. For example, in some embodiments, the display 15 may also provide an icon representing the battery state of charge 20, accumulated hours of operation (not shown) and/or other information relevant to device operation and condition.

The display 15 may be colored, non-colored (e.g., gray-scale), or a combination of both. Although the display 15 is described herein as an LCD display, the display 15 may be implemented as any type of display including LCD, LED, VGA, OLED, SVGA, CRT, or any other alternative configuration known to one of ordinary skill in the art. The display 15 may provide touch-screen functionality. In embodiments where a touch screen is implemented, the scroll button 14 may be omitted.

The controller 13 may include computer executable data to achieve the functions described above. Computer-executable data may include instructions and other data which cause a general purpose computer, special purpose computer, or special purpose processing device to perform a certain function or group of functions. Computer-executable data may also include program modules that are executed by computers in stand-alone or network environments. Program modules may include routines, programs, objects, components, or data structures that perform particular tasks or implement particular abstract data types. Computer-executable data, associated data structures, and program modules represent examples of the program code means for executing steps of the methods, processes and/or functions disclosed herein. The particular sequence of such executable instructions or associated data structures represents examples of corresponding acts for implementing the functions described in such steps.

The tool 1 may be connectable to an external device for purposes of controller software maintenance, collection of data related to hours of use, type of use, battery performance, and/or other relevant data collected by the controller. To this end, the controller may include communication devices and software and associated data storage devices, and be configured to communicate with external devices such as a mobile processing device, a smartphone, a tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art. In some embodiments, communication is achieved via wired connectivity, while in other embodiments, communication is achieved wirelessly.

Wired connectivity may comprise a TCP/IP connection, a local area network (LAN) connection, a plain-old-telephone-service (POTS) connection, an Internet protocol connection, an electrical wiring, a conductive channel, an electrical bus, a fiber optic pathway, or any other alternative embodiment known to one of ordinary skill in the art.

The tool 1 may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art.

In use, the user actuates the scroll button 14 until the icon 18 representing the desired application is backlit. In one example, the user may use the scroll button 14 to select an icon 18(2) that represents metal cutting. Based on the selection of the metal cutting icon 18(2), the controller 13 controls the motor 3 so that the motor 3 may operate within a speed range of 16,000rotations per minute to 20,000 rotations per minute. Prior to operation of the tool, the user may attach an application-appropriate accessory to the accessory interface 9. In this example, a cutting blade accessory may be attached to the accessory interface 9. The user actuates the trigger 11 to cause the motor 3 to drive the accessory 10 and may achieve a fine adjustment of motor speed within the set range by changing the amount of depression of the trigger 11. In this example, if the user decided to follow the cutting application by using the tool 1 to perform a sanding application, the scroll button 14 would be actuated until an icon 18(3) representing a sanding application was backlit in the display 15. If needed, the accessory 10 would be changed to correspond to the newly selected application. In this example, the cutting blade accessory would be removed from the accessory interface 9, and a sanding pad accessory attached to the accessory interface 9. Based on the selection of the sanding icon 18(3), the controller 13 controls the motor 3 so that the motor 3 may operate within a speed range of 10,000 rotations per minute to 15,000 rotations per minute. During use, the user activates the trigger 11 to operate the tool within the set speed range set by the controller 13 and associated with sanding.

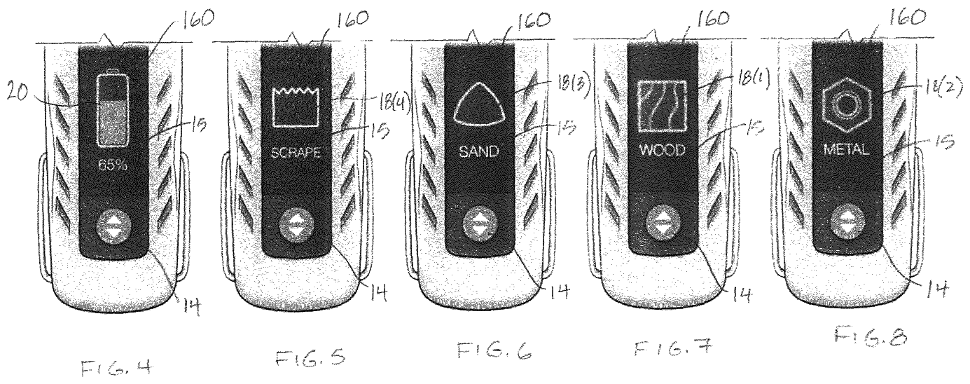

Referring to FIGS. 4-8, the tool 1 may include an alternative embodiment application selector 160. In the application selector 160, the display 15 displays a single icon 18 obtained from a list of several icons stored in memory. In particular, the memory includes a list of icons to be presented to the user, and each icon is associated with (e.g., mapped to) a predetermined range of motor speeds that is appropriate for the application that the icon represents. The icon 18 that is displayed is changed by actuating the scroll button 14. Each time the scroll button 14 is actuated, the icon 18 being displayed is changed by the controller 13, which causes the next icon in the list of icons to be displayed. When the desired icon 18 appears in the display 15, the user stops scrolling. The controller 13 identifies which icon 18 is displayed and sets the backlit icon as the selected application. In addition, the controller 13 limits the operation of the motor 3 to a speed range associated with the displayed icon 18.

In use, the user presses the scroll button 14 until the icon 18 representing the desired application appears on the display 15. In this example, the user may select an icon 18(2) that represents metal cutting. Based on the selection of the metal cutting icon 18(2), the controller 13 controls the motor 3 so that the motor 3 may operate within a speed range of 16,000 rotations per minute to 20,000 rotations per minute. Prior to operation of the tool 1, the user may attach an application appropriate accessory to the accessory interface 9. In this example, a cutting blade accessory may be attached to the accessory interface 9. The user actuates the trigger 11 to cause the motor 3 to drive the accessory 10 and may achieve a fine adjustment of motor speed within the set range by changing the amount of depression of the trigger 11. In this example, if the user would like to follow the cutting operation by using the tool 1 to perform a sanding operation, the scroll button 14 is actuated until an icon representing a sanding application is displayed in the display 15. If needed, the accessory 10 may be changed to correspond to the selected application. In this example, the cutting blade accessory may be removed from the accessory interface 9, and a sanding pad accessory attached to the accessory interface 9. Based on the selection of the sanding icon, the controller 13 controls the motor 3 so that the motor 3 may operate within a speed range of 10,000 rotations per minute to 15,000 rotations per minute. As before, the trigger 11 permits the user to vary the motor speed within the range associated with the selected icon.

Although the tool 1 is described herein as including a mechanism for quickly connecting and disconnecting an accessory from the housing 2 that includes the knob 8 and accessory interface 9, the tool 1 is not limited to employing this type of connection/disconnection mechanism and other embodiments may include alternative structures (not shown) that permit quick connection/disconnection capabilities.

Although the user interface 12 of the tool 1 is described herein as including the scroll button 14, the user interface 12 is not limited to a scroll button 14. For example, the scroll button 14 may be interchanged with other types of interface devices including a thumb wheel, a slide switch or other similar devices.

Although the exemplary embodiments of the application selector 16, 160 are described above for use with an oscillating power tool, the application selector 16, 160 is not limited to being used with an oscillating power tool. For example, the application selector 16, 160 may be used with power tools having a rotary output including drills, saws, rotary multi-function tools, etc. In another example, the application selector 16, 160 may be used in other types of power tools such as heat guns, glue guns or other power tools without a rotating drive shaft. In such cases the variable output may be output temperature. The tool may include a controller that receives the application selection from the user interface, determines an appropriate range of output temperatures for the selected application and then limits the output temperature of the tool to the range of output temperatures appropriate to the application selection. For example, when the power tool is a heat gun, a first application may include melting of plastic, a second application may include shrinking of plastic, a third application may include separation of paint from a painted surface, etc. The user is able to select an icon corresponding to the intended application of the tool, rather than having to input a particular operating temperature or select an appropriate output temperature range from a range of relative output temperatures. By providing for application selection, the tool becomes more intuitive to use since the user does not have to know what absolute output temperature is appropriate for use in a given application.

Selective illustrative embodiments of the power tool and application selector are described above in some detail. It should be understood that only structures considered necessary for clarifying the power tool and application selector have been described herein. Other conventional structures, and those of ancillary and auxiliary components of the power tool and application selector, are assumed to be known and understood by those skilled in the art. Moreover, while working examples of the power tool and application selector have been described above, the power tool and application selector are not limited to the working examples described above, but various design alterations may be carried out without departing from the system and device as set forth in the claims.

We claim,

1. A hand-held power tool, comprising:
a housing;
a motor at least partially disposed within the housing and having a rotational output shaft that is connectable to a tool accessory;
a user interface that is supported on the housing; and
a controller that controls the user interface to display at least one icon representing a unique tool application, and controls the motor to operate in a predetermined speed range based on an application selection obtained from the user interface,
wherein
the user interface is configured to permit the user to perform the application selection from a menu of icons including the at least one icon.

2. The hand-held power tool of claim 1, wherein the user interface is configured to display a single icon, and the hand held power tool includes an icon toggle switch that is connected to the controller, and the controller is configured to change the icon displayed on the user interface upon actuation of the icon toggle switch.

3. The hand-held power tool of claim 1, wherein the user interface is configured to display at least two icons, and the hand held power tool includes an icon toggle switch that is connected to the controller, and the controller is configured to
backlight a single icon of the at least two icons, where backlighting of the icon is interpreted by the controller to correspond to section of the icon by the user, and
permit movement of the backlight from one of the at least two icons to another of the at least two icons by an actuation of the icon toggle switch.

4. The hand-held power tool of claim 1, wherein each icon is mapped to a respective speed range and when an icon is selected by the user, the controller governs the speed of the motor such that the motor is restricted to operation within the respective speed range.

5. The hand-held power tool of claim 4, comprising a trigger that is connected to the controller and is operable by the user to increase and decrease the speed of the motor, and wherein upon operation of the trigger, the controller changes the speed of the motor in accordance with an output of the trigger to an extent defined by the respective speed range.

6. The hand-held power tool of claim 1, wherein
the menu of tool operation applications includes at least two applications,
each of the at least two applications is mapped to a unique range of motor speeds, and
a range of motor speeds of one application is overlapping with a range of motor speeds of another application.

7. The hand-held power tool of claim 1, wherein
the menu of tool operation applications includes at least two applications,
each of the at least two applications is mapped to a unique range of motor speeds, and
the ranges of the motor speeds of the respective applications are non-overlapping.

8. The hand-held power tool of claim 1, comprising
a drive shaft that protrudes from the housing;
a motion change mechanism that connects the output shaft to the drive shaft, the motion change mechanism configured to transform a rotational motion of the output shaft to one of a rotating motion and an oscillating motion of the drive shaft.

9. A system for setting a tool speed range of a power tool, the system comprising:
a power tool including
a motor having an output shaft that is connectable to a tool accessory,
a controller that controls the speed of the motor,
a user interface that presents icons to a user of the tool, at least one icon representing a tool application,
wherein the controller is configured to identify the icon selected by the user, and based on the selected icon, the controller controls the motor to operate in a predetermined range of speed that are associated with the selected icon.

10. The system for setting a tool speed range of a power tool of claim 9, wherein the power tool includes a scroll switch which alters the appearance of the user interface by presenting a different icon, and
the tool speed range of the power tool may be changed by selection of a different icon using the scroll switch.

11. A hand-held power tool, comprising:
a housing;
a user interface that is supported on the housing; and
a controller that controls the user interface to display at least one icon representing a unique tool application, and controls the output of the tool to operate in a predetermined operational range based on an application selection obtained from the user interface,
wherein
the user interface is configured to permit the user to perform the application selection from a menu of icons including the at least one icon.
